(19) United States
(12) Patent Application Publication
(10) Pub. No.: US 2014/0347743 A1
(43) Pub. Date: Nov. 27, 2014

(54) PHOTOGRAPHIC WIDE-ANGLE LENS SYSTEM WITH INTERNAL FOCUSING

(71) Applicant: Jos. Schneider Optische Werke GmbH, Bad Kreuznach (DE)

(72) Inventors: Lingli Wang, Bad Kreuznach (DE); Ihar Shyshkin, Bad Kreuznach (DE)

(73) Assignee: Jos. Schneider Optische Werke GmbH, Bad Kreuznach (DE)

(21) Appl. No.: 14/282,226

(22) Filed: May 20, 2014

(30) Foreign Application Priority Data
May 27, 2013 (DE) 10 2013 105 425.0

(51) Int. Cl. G02B 13/04

(52) U.S. Cl. CPC G02B 13/04
USPC 359/708

(57) ABSTRACT

A photographic wide-angle lens system with internal focusing has a front array (II) of negative refractive power that is rigid within itself and fixed on the object-side, a rear array (III) of positive refractive power that is rigid within itself and fixed on the image side of an aperture diaphragm (A), and a focusing array (II) of positive refractive power having an optical single element (5) that is arranged between the front array (I) and the aperture diaphragm A and is axially movable from a maximum axial position on the object side to a maximum axial position on the image side to vary the focus distance from its maximum to its minimum value. The optical single element of the focusing array (II) has at least one aspheric surface (51, 52) and the image-side end lens (9) of the rear array (III) is configured as a positive, aspheric meniscus lens.

### BACKGROUND

1. Field of the Invention

The invention relates to a photographic wide-angle lens with internal focusing, comprising three lens arrays, namely a front array of negative refractive power that is rigid within itself and is fixed on the object-side, a rear array of positive refractive power that is rigid within itself and is fixed on the image side of an aperture diaphragm, and a focusing array of positive refractive power consisting of an optical single element that is arranged between the front array and the aperture diaphragm and is axially movable, the linear displacement of which from a maximum axial position on the object side to a maximum axial position on the image side allows to vary the focal distance from its maximum to its minimum value.

2. Description of the Related Art

Wide-angle lens systems of this type are known from U.S. Pat. No. 6,545,824 B2.

The known lens system comprises a front array that is configured in the traditional manner as a retrofocus array, having two negative meniscus lenses and one positive plano-convex lens. As is known, the retrofocus array essentially serves for shifting the focal plane of the lens system towards the back, i.e. towards the image-side, in order to design the rear vertex focal distance of the lens system larger than its focal length. This is particularly required with ultrawide-angle lens systems, to provide the necessary space for standardized connections of the lens system to a camera. On the image side of an aperture diaphragm, a rear array is arranged, which with the known lens system consists of a cemented biconvex and plano-concave lens element and of a non-cemented biconvex and plano-concave lens combination. For focusing, i.e. for adjusting the focus distance of the lens system, i.e. for adjusting the distance at which an object must be located in order to be imaged sharply in the detector plane of a connected camera, an optical single element is provided which is arranged between the front array and the aperture diaphragm which can be axially displaced. With the known lens system, this optical single element described here as focusing array is configured as a cemented component made up of a biconvex lens and a meniscus lens. As is known, the advantage of internal focusing is that on the one hand, instead of shifting the entirety of all arrays, only the focusing array with distinctly lower weight and correspondingly lower requirements for a motorized drive is moved, and on the other, the rear vertex focal distance does not change during focusing, and correspondingly none or only minor changes of the image scale occur. A problem with such internal focusing systems however is the correction of aberrations, since during focusing, the relative distances of the central lens range to the front array and the rear array, which are essential for correction, both change. For this reason, the resulting optical capacities are frequently limited. At an image field angle of below 90 degrees, the known lens system reaches merely a focal length of 35 mm at an f-number (ratio of the focal length to the diameter of the effective entrance pupil) of 3.6. The aberrations for the known lens system are stated to be a spherical aberration of up to 0.2%, an astigmatism of up to 0.3%, and a distortion of up to 3%.

A further lens system is known from US 2010/0265596 A1. This comprises a first lens cluster on the object side with a negative meniscus lens and a negative plano-concave lens. On the image side of the first lens cluster, a second lens cluster is arranged that consists of a third, fourth, fifth, sixth, seventh, eighth and ninth lens. The third, fifth, seventh and ninth lens are designed as biconvex lenses, the fourth and eighth lens, as negative meniscus lenses. The fifth and six, as well as the eighth and ninth lens, are each connected with a cemented component. A biconcave lens was used as the sixth lens. The known lens system does not have the ability of internal focusing.

### SUMMARY OF THE INVENTION

The problem of the present invention is to develop a generic lens system such that an increased optical capacity is obtained, using a distinctly lower focal length.

This problem is solved by a photographic wide-angle lens system with internal focusing, comprising three lens arrays, namely, a front array of negative refractive power that is rigid within itself and is fixed on the object-side, a rear array of positive refractive power that is rigid within itself and is fixed on the image side of an aperture diaphragm and a focusing array of positive refractive power having an optical single element that is arranged between the front array and the aperture diaphragm and that is axially movable. Linear displacement of optical single element from a maximum axial position on the object side to a maximum axial position on the image side allows to vary the focus distance from its maximum to its minimum value. The optical single element of the focusing array comprises at least one aspheric surface and the end lens on the image side of the rear array is designed as a positive aspheric meniscus lens.

In this instance, the term “meniscus lens” refers to the basic form curved across the diameter of the lens in question and not necessarily to the equality of signs of the radii of curvature of the front and rear surface that always exists with spherical meniscus lenses. Because of the asphericity as taught by the invention, it is possible that the two surfaces may for example also be of biconvex shape locally, i.e. across a limited radial interval. The latter can be provided particularly for the central area of the end lens, which can extend over up to two thirds of the total diameter.

As a result of the aspheric configuration of the focusing array and in view of the mass of the array or the structural complexity of the array to be moved, it is possible to dispense with disadvantageous measures, such as the use of a cemented component. Instead, as provided in a preferred embodiment, it is possible to utilize a single lens, particularly a biconvex single lens, as focusing array. By the aspherization of at least one of the surfaces of the focusing array, it is possible to counteract the aberrations created in particular because of the principle of internal focusing. This will however require a compensating, likewise aspheric configuration of an element in the rear area of the lens system. For this purpose, the inventors selected the end lens of the rear array, i.e. the end element of the total lens system. A positive aspheric meniscus lens is provided specifically as end lens. This particular position is especially suitable for aspheric compensation. On the one hand, the distance between this correction lens and the detector plane of a connected camera, i.e. the rear vertex focal distance, is constant due to internal focusing, On the other, all of the aberrations introduced by the elements on the object side have totaled up to the axial position of the end lens and can be directly corrected prior to imaging in the image plane without further taking subsequent optical elements into consideration. As demonstrated further below by means of special embodiments of the invention, in this manner it is possible to achieve significantly improved optical capacity in terms of light intensity and error correction with significantly reduced focal length of the lens system. The particular advantage of the principle of internal focusing is preserved, however. In particular, the focusing array is located in the proximity of the aperture diaphragm, i.e. to the one axial position of the lens system where the beam of light has the smallest diameter. Consequently, the focusing array can also be configured with a corresponding small diameter. On the one hand, this has advantages in view of the mass to be moved during focusing; on the other, it facilitates the installation of a motorized drive, because of the smaller diameter of the focusing array, there is still sufficient installation space for a corresponding electric motor radially outside of the focusing array and still within the lens system housing, which is normally cylindrical.

In a preferred embodiment, it is provided that the front array comprises three immediately adjacent negative meniscus lenses with convex surfaces aligned on the object side. As a result of this, a high-quality retrofocus array can be realized which, as provided in a preferred embodiment, moreover has the structural advantage that all three meniscus lenses can be produced from the same type of glass.

The focusing array is arranged advantageously directly adjacent to the aperture diaphragm. As already previously mentioned, the advantage of this measure is that the focusing array is in the immediate proximity to the area of the smallest light beam diameter in the lens system. Accordingly, this will result in a very small minimum diameter of the focusing array, the consequence of which is a particularly large radial installation space for a motorized drive of the focusing array.

Alternatively to this, however, it can also be provided in another embodiment of the invention that a further lens element is arranged between the focusing array and the aperture diaphragm. Preferably, this is designed as a lens of negative refractive power, in particular a biconcave lens. This configuration will only slightly reduce the previously mentioned advantage with respect to the radial installation space, while permitting the creation of a somewhat enlarged axial installation space for the drive of the focusing array and/or for the diaphragm mechanism of the aperture diaphragm.

The rear array preferably is configured as a basic lens system that is capable of imaging. Normally, this is not corrected per se, however. The imaging is in principle essentially performed by means of this basic lens system. The axially preceding lenses serve to a lesser extent for imaging per se, but rather for the special modifications of the imaging, namely moving the focus back by the front array (retrofocus) and adjusting the focusing distance by the focusing array. The correction of aberrations is of course performed in view of all the aberrations that were introduced by all of the previously mentioned elements, so that the basic lens system is usually not corrected in itself.

The rear array, i.e. the basic lens system, in one configuration preferably comprises, from its object-side end to its image-side end, a lens of positive refractive power, a cemented component made up of a biconcave lens and a biconvex lens as well as the above-mentioned end lens designed according to the invention.

Further features and advantages of the invention result from the following specific description and the drawings.

### BRIEF DESCRIPTION OF THE DRAWINGS

FIG. 1 a schematic representation of a first embodiment of a lens system according to the invention.

FIG. 2a shows aspheric aberration, FIG. 2b shows astigmatism, and FIG. 2c shows distortion of a lens system according to FIG. 1, focused to infinity.

FIG. 3a shows aspheric aberration, FIG. 3b shows astigmatism, and FIG. 3c shows distortion of a lens system according to FIG. 1, focused to minimum working distance.

FIG. 4 a schematic representation of a second embodiment of a lens system according to the invention.

FIG. 5a shows aspheric aberration, FIG. 5b shows astigmatism, and FIG. 5c shows distortion of a lens system according to FIG. 4, focused to infinity.

FIG. 6a shows aspheric aberration, FIG. 6b shows astigmatism, and FIG. 6c shows distortion of a lens system according to FIG. 4, focused to minimum working distance.

FIG. 7 a schematic representation of a third embodiment of a lens system according to the invention.

FIG. 8a shows aspheric aberration, FIG. 8b shows astigmatism, and FIG. 8c shows distortion of a lens system according to FIG. 7, focused to infinity.

FIG. 9a aspheric aberration, FIG. 9b shows astigmatism, and FIG. 9c shows distortion of a lens system according to FIG. 7, focused to minimum working distance.

### DETAILED DESCRIPTION OF THE PREFERRED EMBODIMENTS

Identical reference symbols in the figures indicate identical or analog elements.

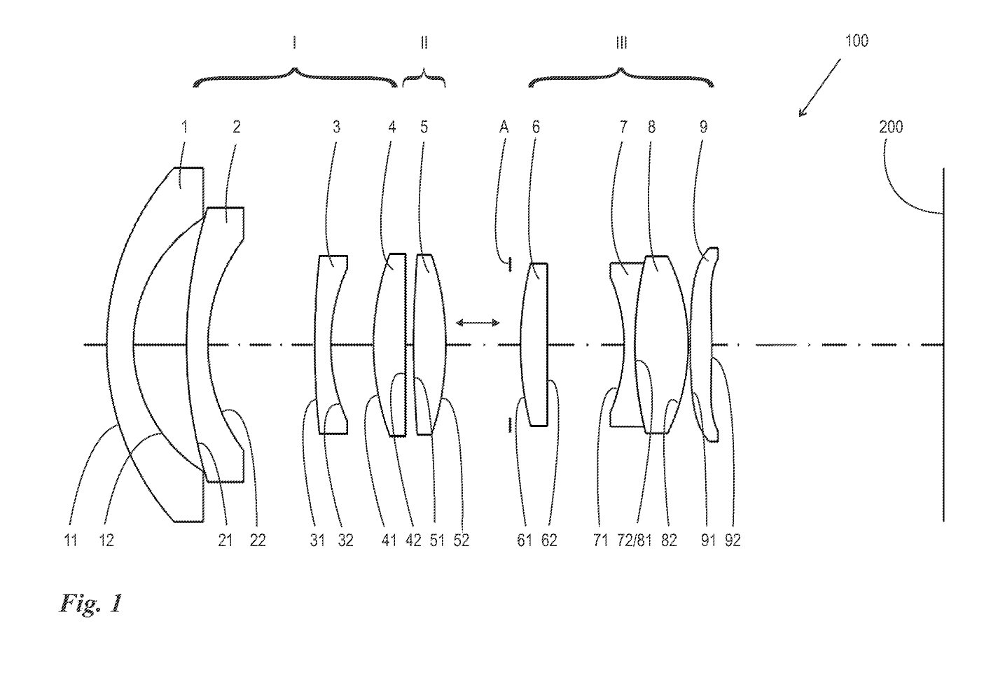

FIG. 1 illustrates a first embodiment of a wide-angle lens system 100 according to the invention. The lens system 100 serves for imaging an object (not shown) onto an image plane 200. The lens system 100 comprises a front array I arranged on the object side, a rear array III arranged on the image side, an aperture diaphragm A arranged on the object side of the rear array III and the focusing array II arranged between the front array I and the aperture diaphragm A. The front array I comprises a first lens 1 with an object-side surface 11 and an image-side surface 12, a second lens 2 with an object-side surface 21 and an image-side surface 22, a third lens 3 with an object-side surface 31 and an image-side surface 32, as well as a fourth lens 4, with an object-side surface 41 and an image-side surface 42. The lenses 1, 2, 3, 4 of the front array I are arranged in a reciprocally rigid manner. The first lens 1 is designed as a negative meniscus lens, its object-side surface 11 comprising a larger radius of curvature than its image-side surface 12. The second lens 2 is likewise designed as a negative meniscus lens, its object-side surface 21 comprising a larger radius of curvature than its image-side surface 22. The third lens 3 is likewise designed as a negative meniscus lens, its object-side surface 31 comprising a larger radius of curvature than its image-side surface. Finally, the fourth lens 4 is lastly designed as a plano-convex lens, its object-side surface 41 being curved.

In the embodiment shown, the focusing array II consists of a single lens with an object-side surface 51 and an image side surface 52, which is designated here as the fifth lens 5. The fifth lens 5 is designed as a biconvex lens, its objects-side surface 51 comprising a larger radius of curvature than its image-side surface. The fifth lens 5 is arranged so that it can be shifted axially, and is preferably motor-driven. It is arranged in the immediate proximity of the aperture diaphragm A. The fifth lens 5 is of aspheric design, both surfaces 51, 52 being preferably aspheric.

The rear array III comprises a sixth lens 6 with an object-side surface 61 and an image-side surface 62, a seventh lens 7 with an object-side 71 and an image-side surface 72, an eighth lens 8 with an object-side surface 81 and an image-side surface 82, as well as a ninth lens 9, with an object-side surface 91 and an image-side surface 92. The lenses 6, 7, 8, 9 of the rear array III are arranged in a reciprocally rigid manner as well as rigid in relation to the front array I and to the aperture diaphragm A. The sixth lens 6 is designed as a plano-convex lens, the object-side surface 61 of which is of curved design. The seventh lens 7 and the eighth lens 8 together forma cemented component, the seventh lens 7 being designed as a biconcave lens and the eighth lens 8 as a biconvex lens. The radius of curvature of the object-side surface 71 of the seventh lens 7 is smaller than the radius of curvature of its image-side surface 72. The radius of curvature of the image-side surface 81 of the eighth lens which is matched to the radius of curvature of the image-side surface 72 of the seventh lens is larger than the radius of curvature of its image-side surface 82. The ninth lens 9, as end lens of the lens system 100, is designed as a positive meniscus lens, the object-side surface 91 of which is of convex design. The ninth lens 9 is designed aspheric, both surfaces 91, 92 preferably being aspheric. Viewed across its entire diameter, the image-side surface 92 of the ninth lens 9 is of concave design; in its central area it is convex, however.

Because of the realized principle of internal focusing, the distance between the front array I and the rear array III and their distance from the image plane 200 is constant, whereas the distance of the fifth lens 5 of the focusing array II to the image plane 200 is variable. In particular, a displacement of the fifth lens 5 in direction of the front array I produces focusing of further distant objects on the image plane 200, and a displacement of the fifth lens 5 in direction of the aperture diaphragm A produces focusing of closer positioned objects on the image level 200.

A preferred concrete configuration of a lens system 100 according to FIG. 1 is rendered in Table 1. All of the numerical values stated here and hereinafter are to be understood as being rounded up to the last digit after the decimal point. In the case of the radius of curvature they refer to the respective surface indicated in the first column, and, in the case of the distance, the refractive index and the Abbe number, to the area between the respective surface indicated in the first column and the surface closest to the image side. The sign of the radius of curvature is selected positive for convex curvatures on the object side and negative for convex curvatures on the image side.

TABLE 1

| | Radius of | | | |
|---|---|---|---|---|
| | curvature | Distance | Refractive | Abbe |
| Surface | [mm] | [mm] | index | number |
| 11 | 24.575 | 2.5 | 1.607 | 56.65 |
| 12 | 13.841 | 4.975 | | |
| 21 | 42.010 | 2.0 | 1.607 | 56.65 |
| 22 | 16.091 | 10.0 | | |
| 31 | 76.225 | 1.5 | 1.607 | 56.65 |
| 32 | 17.133 | 4.0 | | |
| 41 | 24.111 | 3.0 | 1.607 | 56.65 |
| 42 | ∞ | 0.75-3.5 | | |
| 51 (asp) | 85.543 | 3.0 | 1.515 | 63.90 |
| 52 (asp) | −28.983 | 5.0-2.25 | | |
| A | ∞ | 1.0 | | |
| 61 | 31.599 | 2.5 | 1.786 | 44.2 |
| 62 | ∞ | 7.201 | | |
| 71 | −15.823 | 1.0 | 1.846 | 23.82 |
| 72/81 | 38.909 | 5.0 | 1.788 | 47.47 |
| 82 | −18.028 | 0.2 | | |
| 91 (asp) | 66.260 | 2.0 | 1.739 | 49.01 |
| 92 (asp) | −122.66 | 20.458 | | |
| 200 | ∞ | | | |

The aspheric shaped surfaces in the above Table 1 are marked with “asp.” This involves the two surfaces 51, 52 of the fifth lens of the focusing array II and the two surfaces 91, 92 of the end lens, i.e. the ninth lens 9. Here, the indicated negative radius of curvature of the image-side surface 92 refers to its central area. The aspheric coefficients are preferably as follows.

51: A=−0.763039E-05, B=−0.376225E-06, C=0.366786E-08

52: A=−0.180289E-04, B=−0.306385E-06, C=0.330624E-08

91: A=0.877599E-04, B=0.135798E-05, C=0.149129E-08

92: A=0.41240E-03, B=0.109228E-05, C=0.103390E-07

Because of the axial shiftability of the fifth lens 5, the distances of its surfaces 51, 52 change relative to the immediately adjacent surfaces when the focusing is adjusted. In particular, the distance between the fourth lens 4 and the fifth lens 5 varies between 0.75 mm for the “∞” setting and 3.5 mm for the setting to the minimum working distance, i.e. particularly 225 mm. The distance between the fifth lens 5 and the aperture diaphragm A varies correspondingly between 5.0 mm for the “∞” setting and 2.25 mm for the setting to the minimum working distance.

Such a lens system has a focal length between 14.45 mm (“∞” setting) and 13.4 mm (“minimum working distance” setting), an f-number between 2.11 (“∞”) and 2.07 (“minimum working distance”) and an aperture angle between 89.6° (“∞”) and 93° (“minimum working distance”).

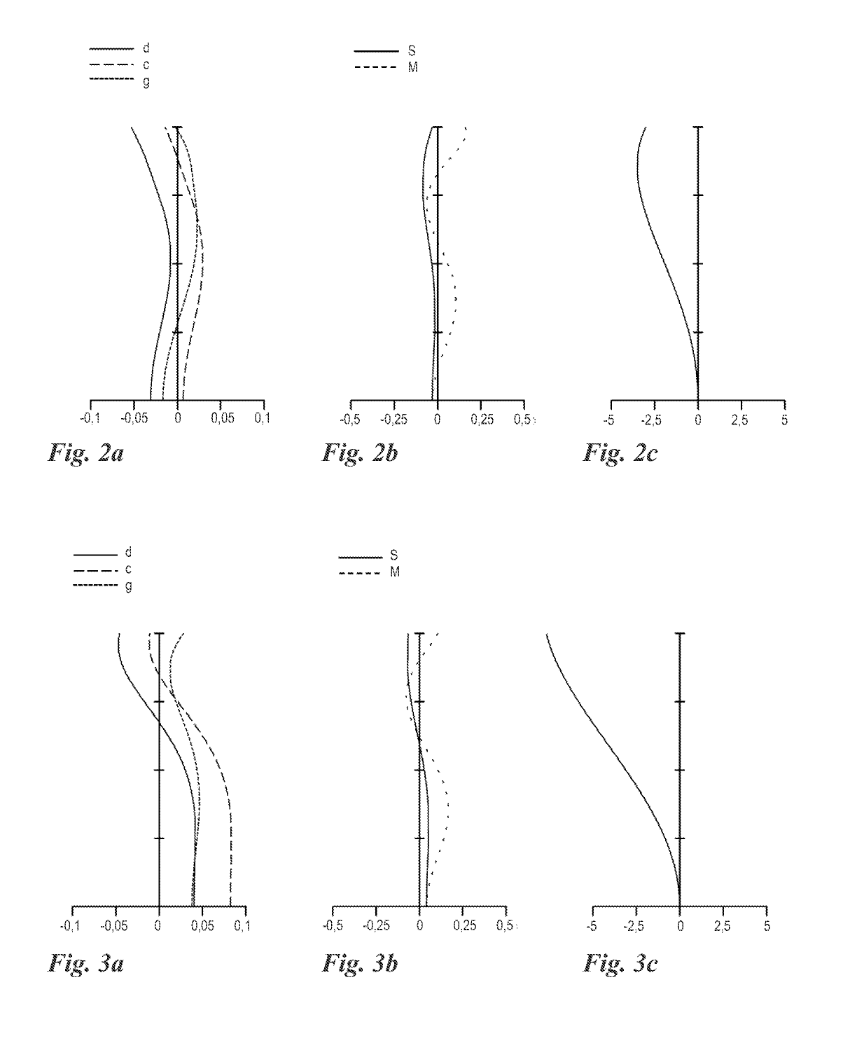

FIGS. 2 and 3 illustrate the respective aberrations, namely FIG. 2 for the “∞” focusing setting and FIG. 3 for the “minimum working distance” focusing setting. In this context, the partial figures a respectively show the spherical aberration in percent for the Fraunhofer lines d, c, and g, the partial figures b respectively show the astigmatism in the sagittal plane (S) and the meridian plane (M), and the partial figures c respectively show the distortion. The numerical data on the X axis are percentages. The Y axis represents half the aperture angle, based upon the optical axis. One can see how extremely small the aberration are, which makes the lens system according to the invention superior to known lens systems.

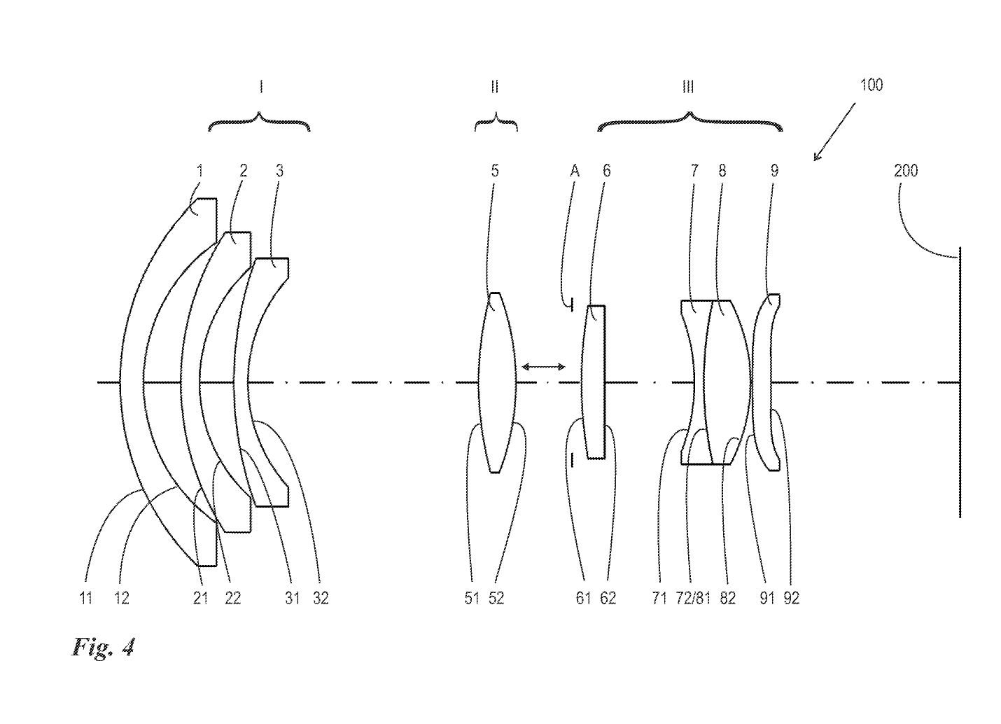

FIG. 4 illustrates a second embodiment of a wide-angle lens system 100′. The fundamental configuration is the same as in the embodiment of FIG. 1; for that reason, when describing FIG. 4, merely the significant differences to FIG. 1 will be detailed. For the rest, reference is made to what was stated above. This specifically also applies to the reference signs introduced and used in conjunction with FIG. 1 and also with FIG. 4.

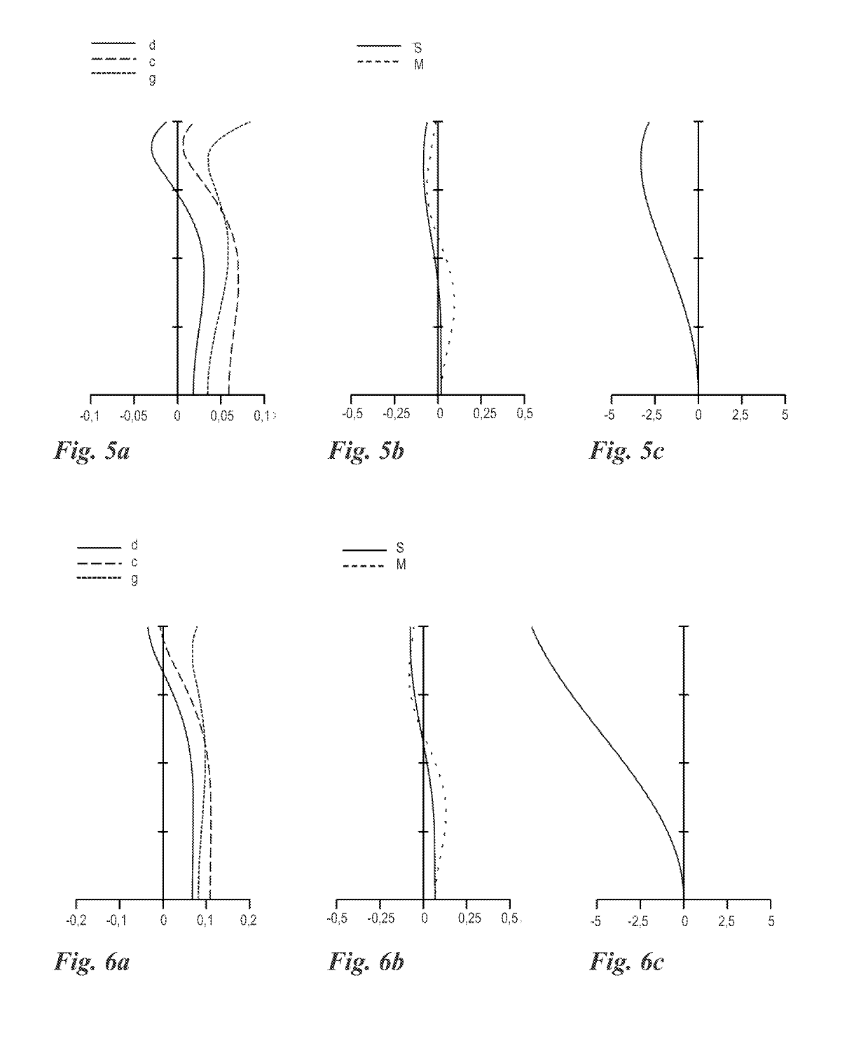

The basic configuration of the embodiment of FIG. 4 compared to the basic configuration of the embodiment of FIG. 1 is characterized above all in that the front array I consists merely of three negative meniscus lenses 1, 2, 3. A fourth lens of the front array I is not provided in the embodiment of FIG. 4. The fact that the fourth lens is absent is compensated by the introduction of a further aspheric surface, namely the object-side surface 61 of the sixth lens 6, as shown in the following Table 2. The absence of the fourth lens cannot be compensated completely, however, as is shown in FIGS. 5 and 6 which, analogous to FIGS. 2 and 3, illustrate the aberrations of the lens system according to FIG. 4, realized with the values of the subsequent Table 2. The comparison of FIGS. 5a and 6a with FIGS. 2a and 3a shows in particular that the spherical aberration in the embodiment according to FIG. 4 is only slightly larger than in the embodiment according to FIG. 1, but is nevertheless clearly less than is known from the prior art.

Preferred values for the concrete configuration of a lens system of the embodiment according to FIG. 4 are as follows:

TABLE 2

| | Radius of | | | |
|---|---|---|---|---|
| | curvature | Distance | Refractive | Abbe |
| Surface | [mm] | [mm] | index | number |
| 11 | 27.089 | 2.5 | 1.607 | 56.65 |
| 12 | 18.129 | 3.995 | | |
| 21 | 29.126 | 2.0 | 1.607 | 56.65 |
| 22 | 16.436 | 3.670 | | |
| 31 | 37.889 | 1.5 | 1.607 | 56.65 |
| 32 | 16.416 | 24.666-28.936 | | |
| 51 (asp) | 34.404 | 4.0 | 1.517 | 64.14 |
| 52 (asp) | −26.530 | 5.0-2.25 | | |
| A | ∞ | 1.0 | | |
| 61 (asp) | 40.924 | 2.5 | 1.517 | 64.14 |
| 62/13 | ∞ | 9.602 | | |
| 71 | −19.886 | 1.0 | 1.846 | 23.82 |
| 72/81 | 39.179 | 5.0 | 1.788 | 47.47 |
| 82 | −18.542 | 0.2 | | |
| 91 (asp) | 315.2 | 2.0 | 1.739 | 49.01 |
| 92 (asp) | −111.77 | 20.237 | | |
| 200 | ∞ | | | |

The aspheric shaped surfaces in the above Table 2 are marked with “asp.” This involves the two surfaces 51, 52 of the fifth lens 5 of the focusing array II, the object-side surface 61 of the sixth lens 6 and the two surfaces 91, 92 of the end lens, i.e. the ninth lens 9. Here, the stated negative radius of curvature of the image-side surface 92 refers to its central area. The aspheric coefficients are preferably as follows.

51: A=−1.63452E-05, B=−0.659234E-07, C=−0.108755E-09

52: A=0.494587E-05, B=−0.748355E-07, 0=0.118988E-09

61: A=−0.179157E-04, B=-0.887314E-07, C=0.252232E-09

91: A=0.139413E-03, B=0.103833E-05, C=0.118247E-08

92: A=0.176934E-03, B=0.102411 E-05; C=0.486927E-08

Because of the axial shiftability of the fifth lens 5, the distances of its surfaces 51, 52 change relative to the immediately adjacent surfaces when the focusing is adjusted.

In particular, the distance between the third lens 3 and the fifth lens 5 varies between 24.7 mm for the “∞” setting and 27.45 mm for the setting to the minimum working distance, namely particularly 225 mm. The distance between the fifth lens 5 and the aperture diaphragm A varies correspondingly between 5.0 mm for the “∞” setting and 2.25 mm for the setting to the minimum working distance.

Such a lens system 100′ has a focal length between 14.46 mm (“””) and 13.06 mm (“minimum working distance”), an f-number between 2.11 (“∞”) and 2.08 (“minimum working distance”) and an aperture angle between 89.6° (“∞”) and 94.6° (“minimum working distance”).

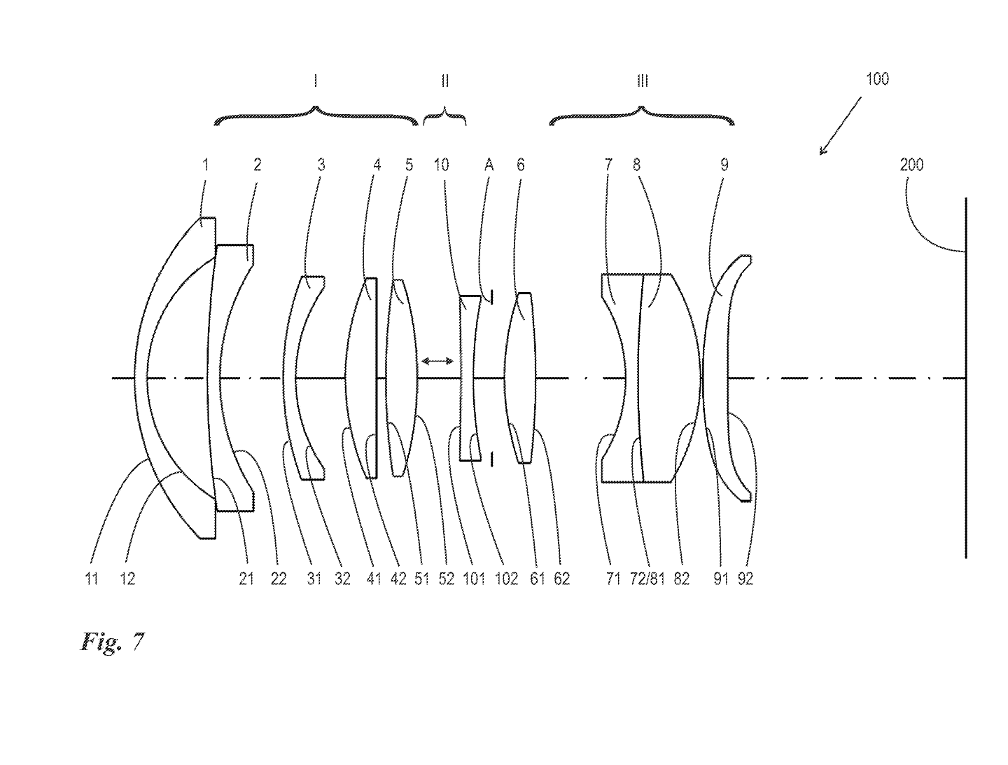

FIG. 7 shows a third embodiment of a lens system 100″ according to the invention which likewise essentially has the same basic configuration as the embodiment of FIG. 1, which is why here as well only the differences from the embodiment of FIG. 1 will be dealt with. For the rest, reference can be made to what has been stated above. In particular, the same reference signs will be used that were already introduced in conjunction with FIG. 1.

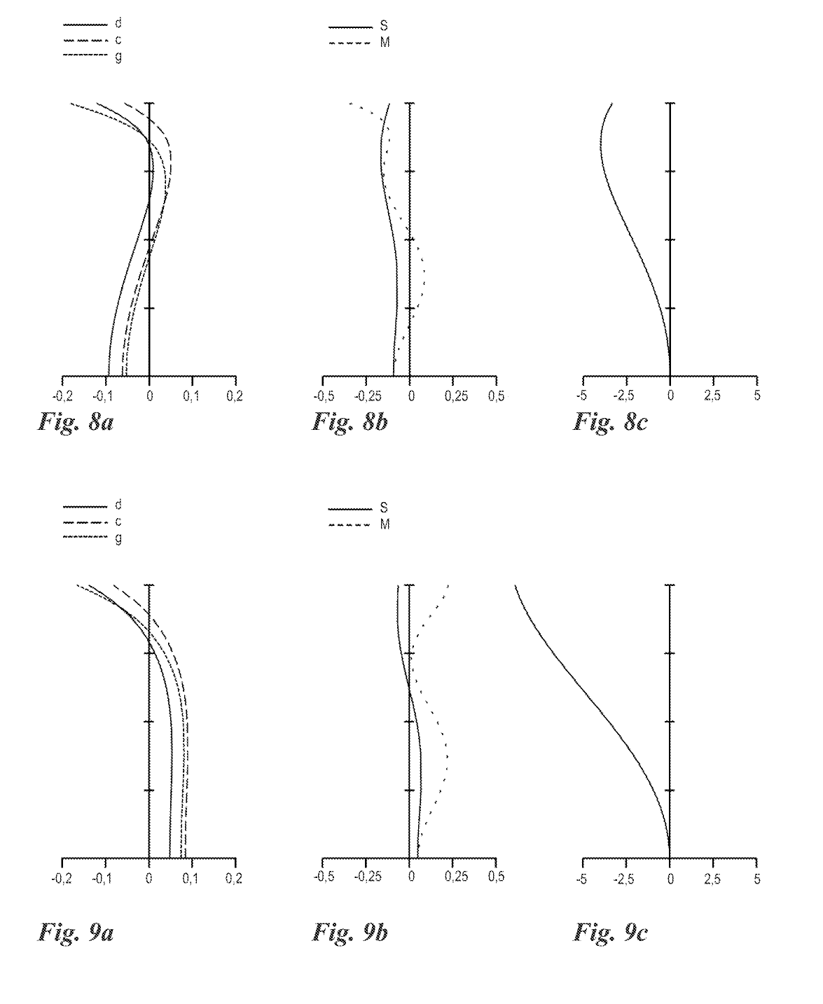

The basic configuration of the lens system 100″ according to FIG. 7 differs from the one of the lens system 100 of FIG. 1 primarily because of an additional tenth lens 10, which, as a negative lens, particularly as a biconcave lens, in particular as a biconcave lens the object-side surface 101 of which has a larger radius of curvature than its image-side surface 102. This additional tenth lens 10 permits a reduction in the number of aspheric surfaces by one. Preferably, the image-side surface 52 of the focusing lens, i.e. the fifth lens 5, is designed spherically, so that the focusing array II comprises only one aspheric surface, namely the image-side surface 51 of the fifth lens 5. Furthermore, there is a change in the sixth lens 6, the image-side surface 62 of which is not plane, but curved. As shown in FIGS. 8 and 9 which, analogous to FIGS. 2 and 3, and/or 5 and 6, represent the aberrations of the lens system 100″ according to FIG. 7, using the values of the subsequent Table 3, in particular the spherical aberration is somewhat worse with close-up focusing than in the other embodiments. Due to the additional tenth lens 10, the weight of the lens system 100″ is also somewhat greater than in the other embodiments. However, because of the absence of an aspheric surface, the manufacture turns out to be simpler and thus more cost-effective.

Preferred values for the concrete configuration of a lens system according to FIG. 7 are reflected in the following Table 3.

TABLE 3

| | Radius of | | | |
|---|---|---|---|---|
| | curvature | Distance | Refractive | Abbe |
| Surface | [mm] | [mm] | index | number |
| 11 | 18.174 | 1.0 | 1.613 | 58.63 |
| 12 | 11.224 | 4.844 | | |
| 21 | 71.694 | 1.0 | 1.613 | 58.63 |
| 22 | 16.591 | 5.077 | | |
| 31 | 22.719 | 1.0 | 1.613 | 58.63 |
| 32 | 12.566 | 4.0 | | |
| 41 | 19.542 | 2.5 | 1.522 | 59.48 |
| 42 | ∞ | 0.75-3.5 | | |
| 51 | 53.089 | 2.5 | 1.465 | 65.77 |
| 52 (asp) | −28.766 | 3.5-0.75 | | |
| 101 | −244.48 | 1.0 | 1.517 | 64.17 |
| 102 | 33.109 | 1.5 | | |
| A | ∞ | 1.0 | | |
| 61 | 20.536 | 2.5 | 1.713 | 53.83 |
| 62 | −57.38 | 7.222 | | |
| 71 | −11.979 | 1.0 | 1.846 | 23.82 |
| 72/81 | 75.278 | 5.0 | 1.788 | 47.47 |
| 82 | −15.623 | 0.2 | | |
| 91 (asp) | 34.235 | 2.0 | 1.743 | 49.31 |
| 92 (asp) | 929.51 (“plane”) | 19.089 | | |
| 200 | ∞ | | | |

The aspheric shaped surfaces are marked with “asp” in the above Table 3. This involves the image-side surface 52 of the fifth lens 5 of the focusing array II and the two surfaces 91, 92 of the end lens, i.e. the ninth lens 9. Here, the stated “plane” radius of curvature of the image-side surface 92 refers to its central area. The aspheric coefficients are preferably as follows.

f52: A=−0.282076E-04, B=−0.348231E-07, C=−0.128230E-09

f91: A=0.697625E-04, B=0.719545E-06, C=0.484016E-08

f92: A=0.137339E-03, B=0.469719E-06, C=0.115923E-0

Because of the axial shiftability of the fifth lens 5, the distances of its surfaces 51, 52 change relative to the immediately adjacent surfaces when the focusing is adjusted. In particular, the distance between the fourth lens 4 and the fifth lens 5 varies between 0.75 mm for the “∞” setting and 3.5 mm for the setting to the minimum working distance, namely particularly 225 mm. The distance between the fifth lens 5 and the tenth lens 10 accordingly varies between 3.5 mm for the “∞” setting and 0.75 mm for the setting to the minimum working distance.

Such a lens system 100″ has a focal length between 14.45 mm (“∞”) and 13.38 mm (“minimum working distance”), an f-number between 2.11 (“∞”) and 2.08 (“minimum working distance”) and a viewing angle between 89.6° (“∞”) and 93.2° (“minimum working distance”).

The embodiments discussed in the specific description and shown in the Figures obviously represent merely illustrative embodiments of the present invention.

In the light of the present disclosure a person skilled in the art has a broad spectrum of optional variations available.

What is claimed is:

1. A photographic wide-angle lens system with internal focusing, comprising three lens arrays (I, II, III), namely
a front array (I) of negative refractive power that is rigid within itself and is fixed on the object-side,
a rear array (III) of positive refractive power that is rigid within itself and is fixed on the image side of an aperture diaphragm (A), and
a focusing array (II) of positive refractive power consisting of an optical single element (5) that is arranged between the front array (I) and the aperture diaphragm A and is axially movable, the linear displacement of which from a maximum axial position on the object side to a maximum axial position on the image side allows to vary the focus distance from its maximum to its minimum value, wherein
the optical single element of the focusing array (II) comprises at least one aspheric surface (51, 52) and the image-side end lens (9) of the rear array (III) is a positive, aspheric meniscus lens.

2. The wide-angle lens system of claim 1, wherein
the optical single element of the focusing array (II) is a biconvex single lens (5).

3. The wide-angle lens system of claim 1, wherein
the front array (I) comprises three immediately adjacent negative meniscus lenses (1, 2, 3) with convex surfaces (11, 21, 31) aligned on the object side, and tha oft are produced from the same type of glass.

4. The wide-angle lens system of claim 3, wherein
the front array (I) on the image side of the three meniscus lenses (1, 2, 3) comprises a plano-convex lens (4) with a convex surface (41) aligned on the object side.

5. The wide-angle lens system of claim 1, wherein
the focusing array (II) of the aperture diaphragm (A) is arranged immediately adjacent.

6. The wide-angle lens system of claim 1, further comprising
a further lens element (10) arranged between the focusing array (II) and the aperture diaphragm (A).

7. The wide-angle lens system of claim 6, wherein
the further lens element (10) is designed as a biconcave lens.

8. The wide-angle lens system of claim 1, wherein
the rear array (III) is configured as a basic lens system that is capable of imaging.

9. The wide-angle lens system of claim 8, wherein
the rear array (III), from its object-side through to its image side end, comprises a lens with positive refractive power (6), a cemented component of a biconcave lens (7) and a biconvex lens (8), and the end lens (9).
